(19) United States
(12) Patent Application Publication
(10) Pub. No.: US 2015/0348147 A1
(43) Pub. Date: Dec. 3, 2015

(54) VOLUME PRICING SEARCH

(71) Applicant: eWinWin, Inc., Tampa, FL (US)

(72) Inventor: Gregory J. Mesaros, Tampa, FL (US)

(21) Appl. No.: 14/733,825

(22) Filed: Jun. 8, 2015

Related U.S. Application Data
(63) Continuation of application No. 13/198,964, filed on Aug. 5, 2011, now abandoned.
Application No. 13/198,964 is a continuation-in-part of application No. 11/618,418, filed on Dec. 29, 2006, now abandoned.
Application No. 11/618,418 is a continuation-in-part of application No. 11/464,376, filed on Aug. 14, 2006, now Pat. No. 7,689,469.
Application No. 11/464,376 is a continuation of application No. 10/370,237, filed on Feb. 20, 2003, now Pat. No. 7,124,099.
Application No. 10/370,237 is a continuation of application No. 09/324,391, filed on Jun. 3, 1999, now abandoned.
(60) Provisional application No. 60/133,769, filed on May 12, 1999.

(51) Int. Cl. G06Q 30/06

(52) U.S. Cl. CPC G06Q 30/0605; G06Q 30/0625

(57) ABSTRACT

A volume pricing system includes a search engine operable to present volume pricing offers to buyers. Buyers utilizing the search engine supply criteria relating to product descriptions, purchasing terms, offer features or the like. The search engine retrieves volume pricing offers from one or more sellers in accordance with the supplied criteria. Furthermore, mechanisms are provided to enable the search engine to discover new offers posted by sellers on other systems.

### CROSS-REFERENCE TO RELATED APPLICATIONS

This application is a continuation of U.S. application Ser. No. 13/198,964, filed on Aug. 5, 2011, entitled, “VOLUME PRICING SEARCH”, which is a continuation-in-part of U.S. application Ser. No. 11/618,418, filed on Dec. 29, 2006, entitled, “VOLUME PRICING SEARCH”, now abandoned, which is a continuation-in-part of U.S. application Ser. No. 11/464,376, filed Aug. 14, 2006 and entitled “E-COMMERCE VOLUME PRICING”, now U.S. Pat. No. 7,689,469, issued on Mar. 30, 2010, which is a continuation of U.S. application Ser. No. 10/370,237, filed on Feb. 20, 2003, and entitled “E-COMMERCE VOLUME PRICING”, now U.S. Pat. No. 7,124,099, issued on Oct. 17, 2006, which is a continuation of U.S. patent application Ser. No. 09/324,391, filed on Jun. 3, 1999, and entitled “E-COMMERCE VOLUME PRICING”, now abandoned, which claims priority to U.S. Provisional Application Ser. No. 60/133,769, filed on May 12, 1999, and entitled “E-COMMERCE VOLUME PRICING”. The entireties of these applications are incorporated herein by reference.

### BACKGROUND OF THE INVENTION

The buying and selling of goods and services (collectively referred to as “products”) has resulted in a vast array of costing schemes, which are used to select the price at which such products are sold. One of the most common costing schemes which consumers encounter everyday is known as fixed pricing. According to this costing scheme, sellers set a fixed price for their products based on a past demand for the product and/or anticipated future demand. Buyers desiring to purchase products from the seller are each required to pay the same fixed price regardless of the number of products purchased. If a seller finds that the demand for a given product is greater or less than expected, the seller may later adjust the fixed price of the product to account for such findings. Although the fixed pricing provides a simple way for a seller to conduct business with multiple buyers, one drawback of this costing scheme is that it fails to reward buyers willing to purchase greater quantities of products. Accordingly, the discount quantity pricing scheme evolved.

The discount quantity pricing approach to costing involves pricing a product at different levels depending on the quantity of products a customer is willing to purchase. The more products a customer is willing to purchase, the lower the price. Sellers have incentive to lower price for large quantity buyers since the fixed costs associated with producing the product is spread over more items. Thus, sellers are able to make equal or greater profits despite the lowered price of the product. While volume pricing offers a benefit to larger buyers who are able to purchase large quantities of goods at one time, smaller buyers are often unable to obtain the lowered prices and therefore are more likely to “shop around” for the best available deal. This, in turn, hurts both the buyer and seller. For instance, the smaller buyer is burdened with needing to search for alternative deals and still often ends up paying a higher price than larger buyers. The sellers, on the other hand, are faced with lost business since they are unable to reduce their price for the smaller buyers and still make sufficient profit.

Another common costing scheme for pricing a product is an auction. In an auction, a seller sets an initial price for an item and then multiple buyers are given an opportunity to bid against each other for the product. The buyer having placed the highest bid for the product at the end of the auction purchases the product at the final price bid. In order to provide a larger forum for buyers and sellers, a recent trend has been to auction goods electronically over the Internet. For example, one company known to operate an auction site over the Internet is eBay, Inc. Although auctions provide advantages when selling unique products for which customers are willing to competitively bid, the auction forum is not well suited for sellers desiring to sell large quantities of goods to multiple buyers given the inherent inefficiencies involved with selling one product at a time in a bidding environment.

Yet another costing scheme, which has been advanced in recent years, is buyer-driven bidding. According to this costing scheme, a single buyer desiring to obtain a product communicates a price at which the buyer is willing to purchase the product from multiple sellers. Each of the sellers is provided an opportunity to review the buyer's price. A sale is complete when one of the sellers agrees to sell the product to the buyer at the price suggested by the buyer. A buyer-driven bidding scheme is described in U.S. Pat. No. 5,794,207 assigned to Walker Asset Management Limited Partnership of Stamford, Conn. While the buyer-driven bidding scheme provides advantages for certain types of transactions when, for example, sellers may be willing to sell products at lower than normal prices, the uncertainties involved with whether a buyer's offer will be accepted is often problematic for high volume commercial transactions in which the reliability that a transaction will be complete is of paramount importance.

While the costing schemes described above have various advantages and disadvantages in different situations, a commonality among all of the costing schemes is that each buyer operates independently with one or more sellers to set a purchase price of a product. For example, in the fixed pricing scheme and discount quantity purchasing scheme, buyers individually determine whether the sellers preset price schedule is acceptable regardless of whether other buyers have decided to purchase the product or not. In an auction, not only do buyers operate independent of other buyers but, in fact, each buyer's decision to place a bid has a negative effect on all other buyers desiring to purchase the same good since the price of the good increases. Similarly, in a buyer-driven bidding scheme, each buyer is completely unaware of the amount other buyers are bidding for a given product.

The independent operations of the buyers stem from a combination of the fact that: 1) the costing schemes discussed above provide little incentive for buyers to work together and 2) there are large inconveniences for buyers to facilitate communication about their buying activities to other buyers. Unfortunately, such independent operation by buyers can result in missed opportunities for both the buyer and seller. For example, in instances where two independent buyers are unable to afford a product, neither buyer informs the seller of their respective desire to purchase the product. Accordingly, sales of the product to these buyers do not take place. Due to the independent operations by each of the buyers, such information is never communicated thereby resulting in missed opportunities for both the buyers and sellers alike.

### SUMMARY OF THE CLAIMED INVENTION

The following presents a simplified summary in order to provide a basic understanding of some aspects of the claimed subject matter. This summary is not an extensive overview. It is not intended to identify key/critical elements or to delineate the scope of the subject invention. Its sole purpose is to present some concepts in a simplified form as a prelude to the more detailed description that is presented later.

Briefly described, the subject disclosure pertains to systems and methods directed toward e-commerce transactions and demand aggregation. More particularly, mechanisms are provided to assist buyers in discovering desired deal rooms, or electronic forums, for buying goods and/or services at a volume discount as a function of collective room purchases. For some sellers, it is difficult to inform proper buyers of a particular offer. For example, advertising in periodicals or on television and/or radio are broad, undirected means of advertising. By providing directed offers to already interested buyers, sellers are motivated to participate in volume pricing in order to receive effective advertising. Further, both buyers and sellers can benefit from such volume pricing. For example, sellers can utilize deal rooms for optimal production scheduling and/or inventory reduction, while buyers can be grouped to benefit from bulk discounts that may be otherwise unavailable to individuals or small entities.

According to aspect of this disclosure, a volume pricing offer discovery system is provided that includes a query input component and a search engine component. The query input component accepts product purchasing criteria from a buyer. The search engine component utilizes the criteria accepted by the query input component to retrieve group purchasing offers from one or more sellers. A prospective buyer may review the retrieved offers and select one to begin transacting with the seller.

In accordance with another aspect of the claimed subject matter, a mechanism is provided to locate, retrieve and index group purchasing offers. Sellers can post group purchasing offers to a website or other location on the Internet. These offers are discovered and indexed in a database for future retrieval.

According to yet another aspect of the disclosure, mechanisms are provided to sort and filter offers retrieved by the search engine component. Offers can be sorted based upon a most relevant criterion selected by the buyer or according to an intelligence choice. Additionally, certain offers can be filtered from viewing by the buyer based upon criteria provided by the seller. For example, a buyer with a lower credit ranking may not receive a particular offer.

To the accomplishment of the foregoing and related ends, the invention then, comprises the features hereinafter fully described and particularly pointed out in the claims. The following description and the annexed drawings set forth in detail certain illustrative aspects of the invention. These aspects are indicative, however, of but a few of the various ways in which the principles of the invention may be employed and the subject invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 is a block diagram of a volume pricing search system.

FIG. 2 is a block diagram of a volume pricing offer discovery system.

FIG. 3 is a block diagram of a volume pricing offer search system including a sorting component.

FIG. 4 is a block diagram of a volume pricing offer search system including a result filtering component.

FIG. 5 is a block diagram of an invoice tracking system.

FIG. 6 is a block diagram of a volume pricing offer search system including a hosted search engine.

FIG. 7 is a flow chart diagram of a method of volume pricing offer searching.

FIG. 8 is a flow chart diagram of a method of volume pricing purchasing utilizing a search engine.

FIG. 9 is an exemplary search criteria input screen in accordance with an aspect of the subject innovation.

FIG. 10 is an exemplary output screen depicting results of the search engine.

FIG. 11 illustrates a diagrammatic view of a system for electronically conducting business.

FIG. 12 is a block diagram of a representative central server in accordance with an aspect of the innovation.

FIG. 13 illustrates an exemplary web page providing options to buyers and sellers desiring to conduct business electronically.

FIG. 14 illustrates a deal room in which buyers may place electronic orders for products posted by sellers.

FIG. 15 is a flow chart diagram for a buyer desiring to conduct business electronically.

FIG. 16 illustrates an on-line registration form for a buyer.

FIG. 17 illustrates a representative buyer database.

FIG. 18 is a web page for a buyer to search for a desired deal room.

FIG. 19 is a flow chart diagram for a seller desiring to conduct business electronically.

FIG. 20 illustrates an on-line registration form for a seller

FIG. 21 illustrates a representative seller database

FIG. 22 illustrates a representative web page for a seller to open or visit a deal room

FIG. 23 illustrates a product information sheet completed by a seller opening a deal room.

FIG. 24 is a schematic block diagram illustrating a suitable operating environment for aspects of the subject innovation.

FIG. 25 is a schematic block diagram of a sample-computing environment.

### DETAILED DESCRIPTION

The subject disclosure pertains to searching for volume pricing offers. More specifically, the disclosure is related to mechanisms that facilitate discovery, gathering and indexing of volume pricing offers to be retrieved later by interested buyers. In accordance with one embodiment, a search engine is provided. The search engine includes mechanisms to scour the Internet or local networks for volume pricing offers posted by suppliers. The volume pricing offers include price curves that that vary as a function of an amount of product ordered/purchased. A buyer, desiring to aggregate purchases with other buyers, utilizes the search engine to find volume pricing offers and to participate in electronic deal rooms attached to the offers. Various systems and methods are described hereinafter with respect to volume pricing offer searching as well as relevant tools to aid such functionality.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

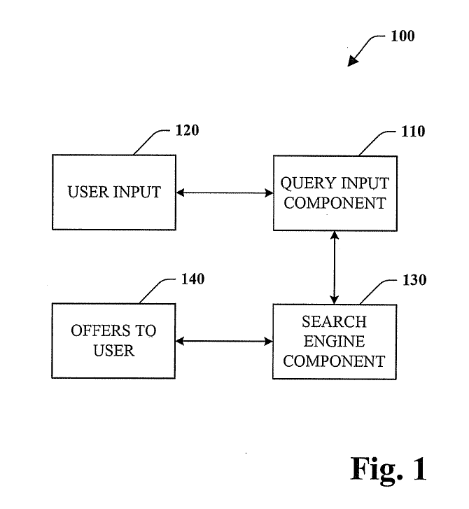

Referring initially to FIG. 1, a searching system for volume pricing offers 100 is illustrated. Searching system 100 includes a query input component 110 and a search engine component 130. The query input component 110 accepts user input 120 that is provided by a user (not shown). The user may be a potential buyer seeking suppliers of particular products or class of products. It is to be appreciated that the user may also be a supplier seeking to determine what products competitors are selling and what volume pricing offers competitors are providing. In one embodiment, the user can supply user input 120 via a web browser on a personal computer such as Microsoft Internet Explorer, Netscape Navigator, Mozilla Firefox, or the like. It is to be appreciated that the user may also provide user input 120 via a mobile device, such as a cellular phone or a personal digital assistant (PDA), or any device capable of interfacing with the searching system 100.

User input 120 can include a variety of criteria supplied by the user. For example, the criteria can comprise a description of the product, lowest current price, best potential future price, ship date, order volume minimum, warranty term, seller rating and the like. The user input 120 is provided to query input component 110 to locate volume pricing offers in accordance with the criteria included in the user input 120. The query input component 110 translates the user input into a format suitable for searching a data store. The particular format utilized is dependent on the type of data store employed by the searching system 100. For example, if the data store is a relational database, the query input component 110 may translate the user input into Structured Query Language (SQL). If the data store is XML, the query input component 110 may utilize an XQuery or XPath format. Alternatively, if user input is already in a suitable format, the query input component can simply pass such data through.

The query input component 110 is communicatively coupled to search engine component 130. The query input component 110 communicates the translated query to the search engine component 130. Search engine component 130 employs the translated query to search a data store (not shown) for volume pricing offers matching the user's criteria. Matching volume pricing offers 140 are retrieved from the data store and returned to the user for review. The matching volume pricing offers 140 may be presented to the user as a list of offers with details of the offers provided therewith. For example, each offer in the list may include a name of the supplier, a current price under the group buy and a ship date. The volume pricing offers 140 may be a link that enables the user to execute an order or redirects the user to an electronic forum or deal room to conduct the transaction.

In addition to individual volume pricing offers, search engine component 130 can supply the user with a macroscopic view of a product category or supplier. For example, the user may desire to review an average price per unit of a particular product. The search engine component 130 can retrieve past or present volume pricing offers in the desired product category and determine the average price per unit which is subsequently conveyed to the user. The search engine component 130 can provide the user with a cost per average volume ordered, regional differences, pricing trends and the like to enable the user to confirm that pricing for a product is acceptable.

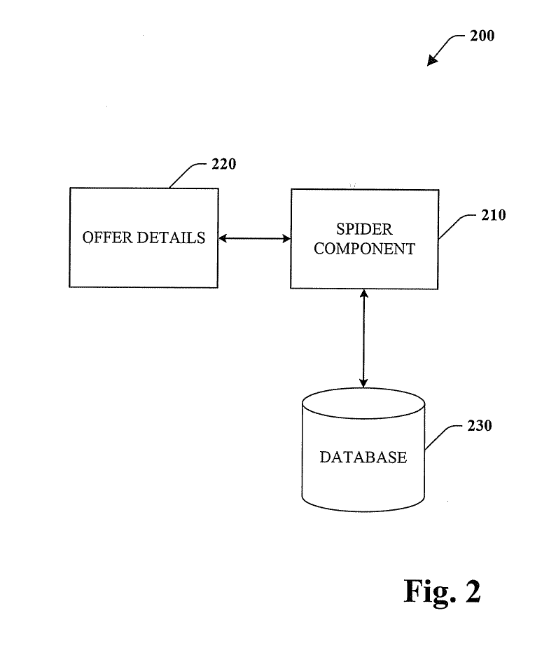

Turning now to FIG. 2, a volume pricing offer discovery system 200 is depicted. System 200 includes a spider component 210 that traverses the Internet or other network to find volume pricing offers listed by a supplier. In one instance, a supplier can post the offer details 220 on the supplier's website, another website (e.g., industry website, electronic magazine . . . ) a bulletin board or some other accessible medium on the Internet. Offer details 220 may include a company name of the supplier, an industry of the supplier, supplier locations, products and/or services offered, a price curve, a ship date, a minimum order volume, a warranty term, a number of defects as a percentage and the like.

The spider component 210 can locate offer details 220 by utilizing metatags or some other identification signature included in the offer details 220. The spider component 210 retrieves the offer details 220 from a website or other location storing the details 220 and parses the retrieved offer details 220 to identify the component parts of the offer. After parsing the offer details, the spider component 220 indexes the offer and stores the offer in a database 230 for future retrieval by a user employing the search engine system 100 from FIG. 1. Database 230 can be a relational database management system but it should be appreciated that other data store formats may be employed.

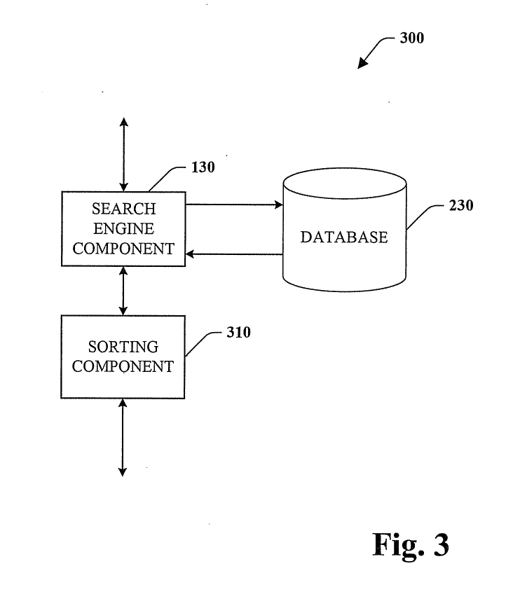

FIG. 3 depicts a volume pricing offer search system 300 including a sorting component 310 in accordance with an aspect of the subject disclosure. Search engine component 130 searches database 230 and retrieves volume pricing offers matching criteria supplied by the user. The sorting component 310, communicatively coupled to the search engine component 130, obtains from the search engine component 130 the volume pricing offers retrieved from the database 230.

The sorting component 310 ranks the retrieved offers prior to presentation to the user. Ranking is based upon a criterion supplied by or otherwise obtained from the user (e.g., search profile, preferences . . . ). For example, the user may desire to rank retrieved offers by lowest current price. In accordance with that choice, the sorting component 310 ranks the retrieved offers according to the current price of the offers. The sorting component 310 presents the offer with the lowest offer first and then the offer with the second lowest price followed by all other retrieved offers from low to high current price. The user is notified of the top ranking result by a visual alert. For example, the top ranking offer may be presented in a different typeface, include explanatory information indicating that the offer is the top ranking offer or spatially offsetting or delineated the top offer. It is also to be appreciated that graphical icon or symbol may be utilized to indicate the top ranking offer such as a star, asterisk, or the like.

The sorting criterion may be supplied to the sorting component 310 at the time the user also supplies the search criteria to system 300. It is to be appreciated that such criterion can be supplied to the sorting component 310 after the retrieved offers are presented to the user. In such case, the user may change the criterion to reflect a different view of the retrieved offers desired by the user. Moreover, while sorting component 310 and search engine component 130 are depicted as separate objects, it is to be appreciated that sorting component 310 may be included within the search engine component 130.

The sorting component 310 can employ machine learning or artificial intelligence techniques to facilitate ranking of retrieved offers. For example, the user may select lowest price as the most important criterion. The sorting component 310 may display retrieve orders from low to high in terms of price. Additionally, the sorting component 310, utilizing artificial intelligence techniques, may make an intelligence choice and present a top ranking offer that does not have the lowest current price. For example, offer A has a current price of $1.10 per unit and the offer closes in 2 days. Offer B has a current price of $1.15 per unit and closes in 5 days. Based upon prior offers from the supplier linked to offer B, it has been typically shown that an average final price of $1.00 per unit results. Accordingly, offer B may be ranked above offer A because of a greater potential for an ultimate drop in price.

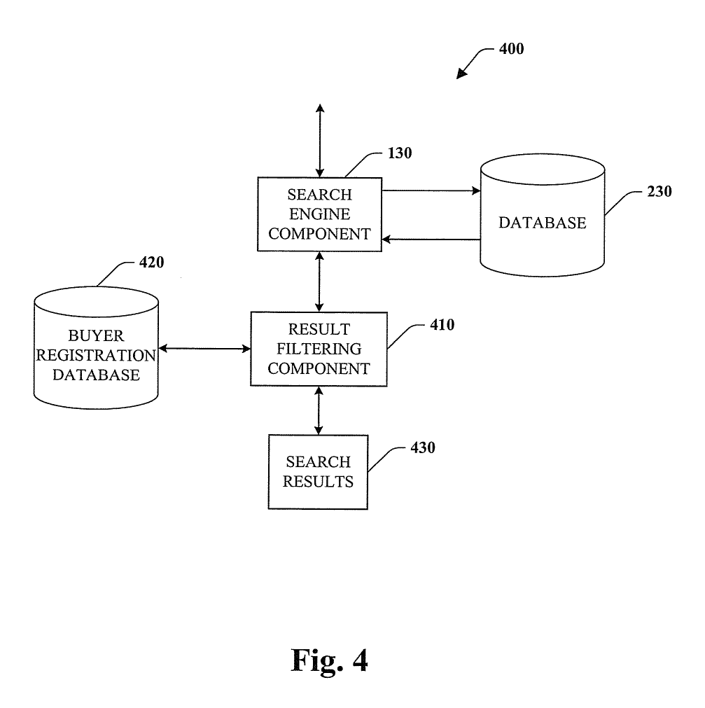

Referring now to FIG. 4, a volume pricing offer search system 400 is illustrated. System 400 includes a result filtering component 410 that provides search results 430 to the user. Search engine component 130 searches database 230 and retrieves volume pricing offers matching criteria supplied by the user. Result filtering component 410 is communicatively coupled to the search engine component 130. Search engine component 130 provides offers retrieved from database 230 to the result filtering component 410. The result filter component 410 processes the retrieved offers and presents search results 430 to the user. The search results 430 include all of the retrieved offers or a subset of those offers based upon criteria specified by the seller and included in the offers.

The seller criteria included in the offers may comprise a minimum credit rating, a minimum historical purchase volume and the like. The result filtering component 410 presents an offer to the user if the user meets or exceeds the seller criteria included in the offer. In other words, the supplier can control which buyers utilizing the search system 400 may view offers. The offer established by the supplier can be multifaceted and comprise a plurality of price curves. In one embodiment, the supplier, in the offer, dictates the criteria required to a present one of the plurality of price curves. For example, a small buyer with a poor credit rating utilizing search system 400 will be presented with one version of a supplier's offer with a first price curve. A larger buyer with a good credit rating utilizing search system 400 may also be presented with the supplier's offer but with a second more favorable price curve. Accordingly, the supplier can indicate which buyers may see an offer at all and also provide for a more discriminating filtering by creating criteria dictating when a buyer is qualified to see particular features of a multifaceted offer. Thus, offers returned from utilizing the search system 400 may be determined by parameters provided by buyers and/or suppliers.

Although not limited thereto, in order to utilize search system 400, a user may be required to register. In furtherance thereof, the user can completes a registration form including a company name, a credit ranking, a monetary amount purchased in a plurality of product areas and the like. The information included in the registration form can be stored in a buyer registration database 420. Buyer registration database 420 may be a database system similar to database 230. For example, buyer registration database may be a relational database management system. It is to be appreciated that a variety of data store systems may be employed to implement the buyer registration database 420.

Result filtering component 410 is communicatively coupled to buyer registration database 420. Result filtering component 410 queries the buyer registration database 420 to retrieve a user profile corresponding to the user utilizing the search system 400. The result filtering component 410 identifies supplier criteria in the offers retrieved from the database 230 by the search engine component 130. The result filtering component presents search results 430 to the user. Search results 430 include retrieved offers wherein the user profile meets the supplier criteria identified in the offers.

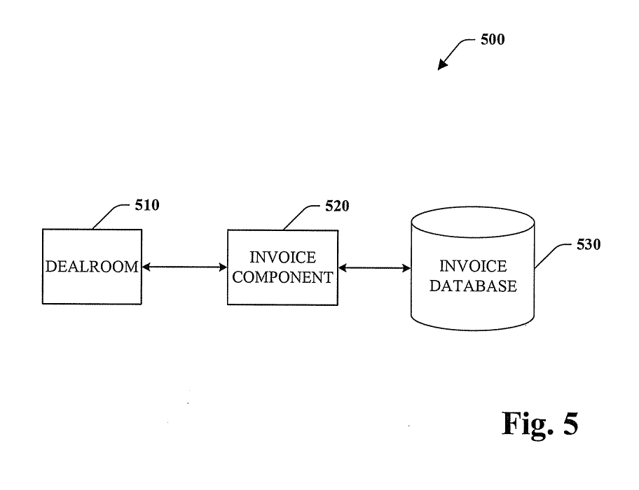

Turning now to FIG. 5, an invoice tracking system 500 is depicted. System 500 includes an electronic forum or deal room 510 that facilitates a business transaction between buyers and suppliers. The deal room 510 is linked to an offer in database 230 (FIG. 3) retrieved by the search engine 130 (FIG. 1). In other words, the deal room 510 can be established as a function of terms and conditions of a supplier's offer. Deal room 510 provides a forum in which a plurality of buyers aggregate purchasing products and/or services from a supplier. The plurality of buyers ultimately pay a final price based upon the total aggregated volume ordered and in accordance with a price curve included in the offer in a deal room and/or across multiple deal rooms with differing price curves. A buyer benefits from a high volume price by linking to purchases of a plurality of buyers.

In accordance with one aspect of the subject disclosure, system 500 includes an invoice component 520. When a buyer completes a transaction utilizing deal room 510, the invoice component 520 creates an open invoice. The open invoice includes all aspects of the business transaction conducted in deal room 510. For example, the open invoice includes a current price, a potential price and an order quantity. The invoice component 520 stores the open invoice in an invoice database 530. Database 530 may be a relational database management system but it is to be appreciated that any data management system can be employed. Database 530 may be contained on a central server or at the same location as search engine component 130 and database 230. However, it should be appreciated that database 530 and the open invoice may be stored on the buyer's system or the supplier's system.

As additional orders are made by other buyers utilizing the deal room 510, the current price of the products and/or service of the offer may decrease in accordance with the price curve. Invoice component 520 tracks the progression of the current price in the deal room 510 and updates the open invoice stored in the invoice database 530. When the buyer accesses the search system or the deal room 510 again, the invoice component notifies the buyer that the open invoice has been updated and may be reviewed. Again, the open invoice can be stored on the buyer's system. In such case, the invoice component 520 can automatically update the open invoice and a current price can always be presented to the buyer. For example, the open invoice may be an applet or widget on the buyer's system. The applet or widget is communicatively coupled to the invoice component 520 and receives updates as additional transactions occur in deal room 510. Accordingly, the buyer may quickly review the current price of products and/or services of the offer without requiring additional buyer interaction.

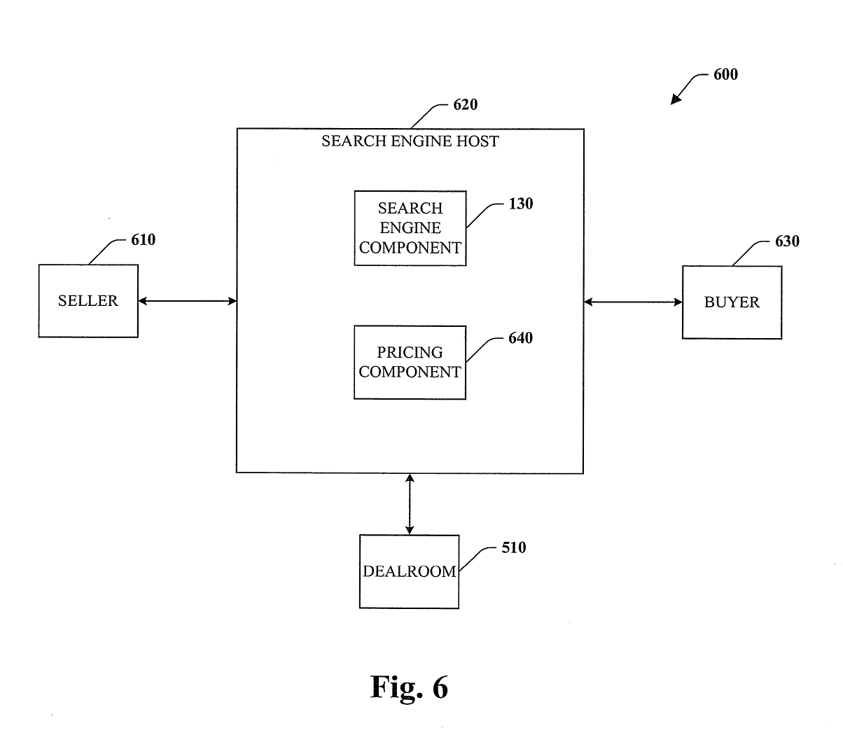

Referring now to FIG. 6, a volume pricing offer search system 600 is illustrated. System 600 includes a buyer 630 and a seller 610 interacting with a hosted search engine 620. Seller 610 provides volume pricing offers to the search engine 620. Search engine host 620 gathers the volume pricing utilizing the spider component 210 describe with regard to FIG. 2. Buyer 630 utilizes search engine 620 to locate volume pricing offers supplied by seller 610 and other sellers as describe in relation to FIG. 1. Search engine host 620 may also host and sponsor the deal room 510 to facilitate business transactions between seller 610 and buyer 630. According to one embodiment, search engine host 620 receives a sales commission on business transactions conducted in deal room 510. Thus, search engine host 620 is incentivized to host the search engine and recruit new sellers and buyers to utilize the search engine.

In accordance with an aspect of the subject disclosure, the search engine host 620 includes the search engine component 130 (FIG. 1) and a pricing component 640. Pricing component 640 facilitates recruiting seller 610 to participate in volume pricing by generating a price curve to be included with an offer supplied by seller 610. Pricing component 640 may be communicatively coupled with the spider component 210 from FIG. 2 in order to achieve an equitable price curve consistent with offers for similar products and/or services. Pricing component 640 can also generate a plurality of price curves from which seller 610 selects one to be included with the offer. Alternatively, according to another embodiment, the seller 610 provides a price curve with the offer.

Under the hosted search engine system, seller 610 is provided with a valuable way to sell products. In exchange for participating in volume pricing, seller 610 receives free advertising of its products from the search engine host 620. That is, its products are visible to buyer 630 without fee. According to another embodiment, the seller 610 may desire to increase the visibility of an offer and, accordingly, can pay a fee to display the offer as a highlighted or recommended offer. Pricing component 640 further reduces the challenges of participating in volume pricing by providing seller 610 with a price curve to be included with an offer. The search engine host 620 is encourage to provide this level of service to new sellers because more commissions accumulate as more offers become accessible via the search engine. Accordingly, the incentivized search engine host 620 generates volume pricing opportunities that might be otherwise unavailable to buyer 630 and seller 610.

In another embodiment of the subject disclosure, the search engine host 620 can be the buyer 630. Buyer 630 may be a high volume buyer of a plurality of products and/or services and may desire to utilize a private search engine. For example, buyer 630 may be a government. Buyer 630 utilizes the search engine including the spider component 210 from FIG. 2 to retrieve, index and review volume pricing offers.

The aforementioned systems, architectures and the like have been described with respect to interaction between several components. It should be appreciated that such systems and components can include those components or subcomponents specified therein, some of the specified components or sub-components, and/or additional components. Sub-components could also be implemented as components communicatively coupled to other components rather than included within parent components. Further yet, one or more components and/or subcomponents may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the search engine component 130 can utilize such techniques to facilitate provisioning of relevant search results to users as a function of context including user, third party and environmental context. For example, the search engine component can infer that a user may be interested in a particular deal as a function of previous purchases, the time of year, business and/or personal needs, among other things. Furthermore, such deals may be pushed to a user without explicit/manual initiation of a search, for instance as a notification generated as a result of standing or automatic search query as a function of context.

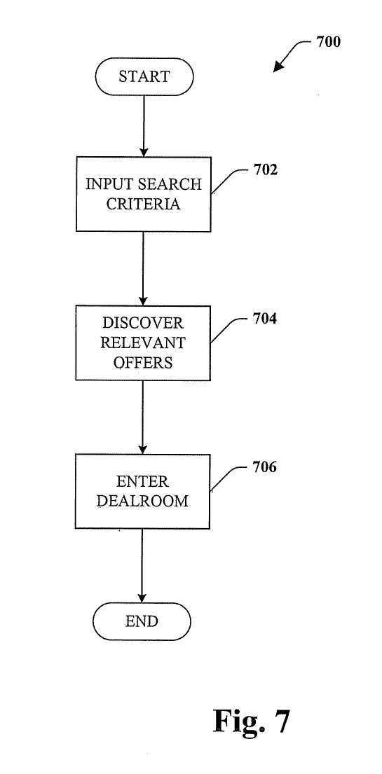

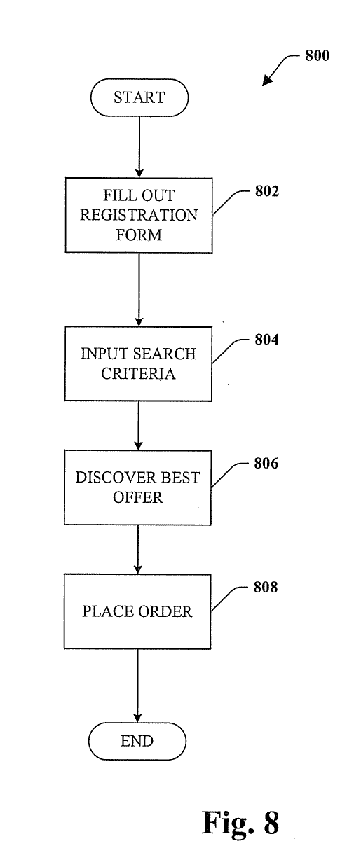

In view of the exemplary systems described supra, methodologies that may be implemented in accordance with the disclosed subject matter will be better appreciated with reference to the flow charts of FIGS. 7 and 8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring now to FIG. 7, a method for volume pricing search 700 is provided. In particular, a search engine can be employed to gather volume pricing offers. A buyer utilizing the search engine can then retrieve those offers.

At reference numeral 702, search criteria is input. The search criteria can be supplied by a buyer seeking to purchase products and/or services described by the search criteria. The search criteria includes, among other things, a description of the product, lowest current price, best potential future price, ship date, order volume minimum, warranty term, and seller rating.

At numeral 704, relevant offers are discovered. Relevancy of an offer can be determined by comparing the details of the offer with the search criteria inputted at numeral 702. A search engine may be employed to retrieve offers from a data store utilizing a query based upon the search criteria. The retrieved offers can be presented to the buyer supplying the search criteria at numeral 702.

At numeral 706, the buyer enters a deal room and to conduct a business transaction. For instance, a buyer can choose a particular offer from the relevant offers discovered at reference numeral 704. The deal room entered by the buyer can correspond to the offer chosen by the buyer. The offer may include a company name of the supplier, an industry of the supplier, supplier locations, products and/or services offered, a price curve, a ship date, a minimum order volume, a warranty term, a number of defects as a percentage and terms and conditions of the offer. The business transaction in the deal room is conducted in accordance with the details of the offer. Further, the buyer, prior to accessing the deal room, accepts the terms and conditions of the offer.

Turning now to FIG. 8, a method for searching for volume pricing offers 800 is provided. At reference numeral 802, a buyer fills out a registration form in order to gain access to a search engine. The registration form includes, among other things, a company name, a credit ranking and a monetary amount purchased in a plurality of product areas. At numeral 804, the buyer inputs search criteria into a search engine. At reference numeral 806, the search engine discovers the best offers matching the search criteria provided at reference numeral 804. Further, only offers wherein the information entered at reference numeral 802 matches criteria in the offer supplied by the seller. At reference numeral 808, an order is placed in accordance with the offer.

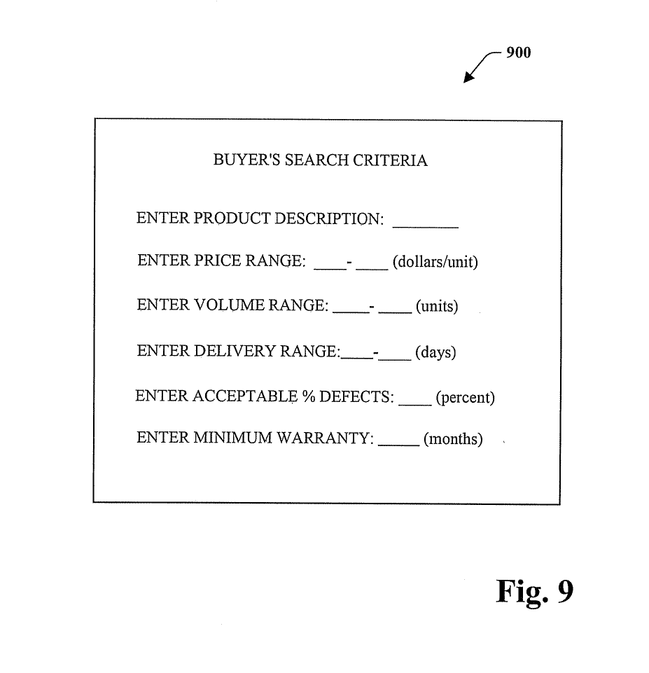

What follows are exemplary input and output screens provided to facilitate understanding with respect to aspects of subject disclosure. Turning to FIG. 9, an exemplary buyer input screen 900 is depicted. A buyer utilizing input screen 900 can supply search criteria to a search engine operable to retrieve volume pricing offers. Input screen 900 enables a buyer to indicate a description of a desired product, an acceptable price range, a volume range, a time period range associated with a delay time resulting from shipping concerns, a maximum acceptable percentage of defects and a minimum warranty term.

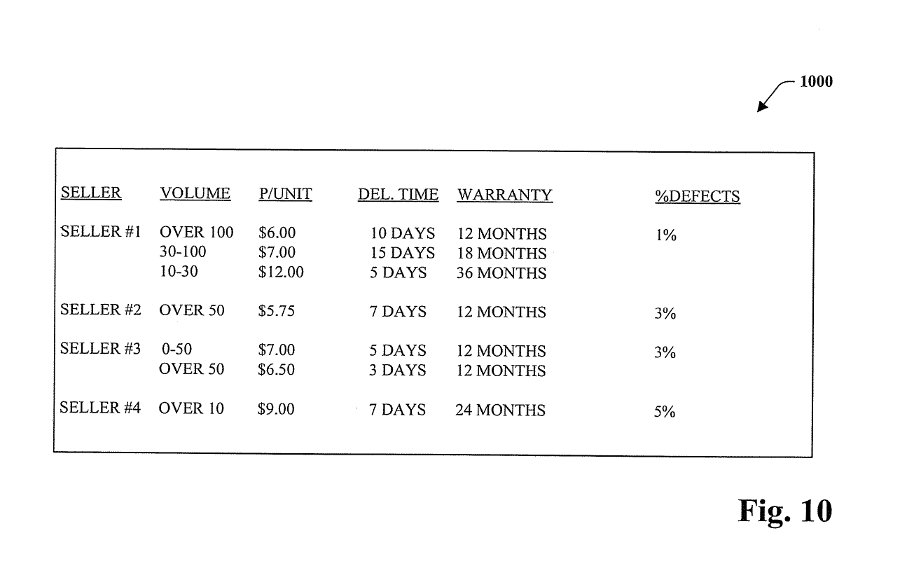

Referring now to FIG. 10, an exemplary output screen 1000 is illustrated. Output screen 1000 depicts a plurality of offers retrieved by a search engine in accordance with search criteria supplied by a buyer. The offers are presented to a user including a name of the seller, a price curve presented as a volume and corresponding unit price, a delay time associated with shipping time, a warranty duration and a percentage of defects. The plurality of offers depicted in output screen 1000 can be ranked according to a most important criterion selected by a buyer. For example, in output screen, the plurality offers are ranked according to the percentage of defects with the offer with the lowest occurrence of defects presented first and the offer with the highest occurrence of defects presented last.

What follows is an exemplary implementation of a demand aggregation system as well as system setup and interaction therewith. It is to be appreciated that this is but one manner in which aspects of the disclosure can be employed. Others are possible and are to be deemed within the scope of the claimed subject matter. Further yet additional details regarding the below described mechanisms and interactions can be found in the aforementioned patent application entitled E-COMMERCE VOLUME PRICING, incorporated herein by reference.

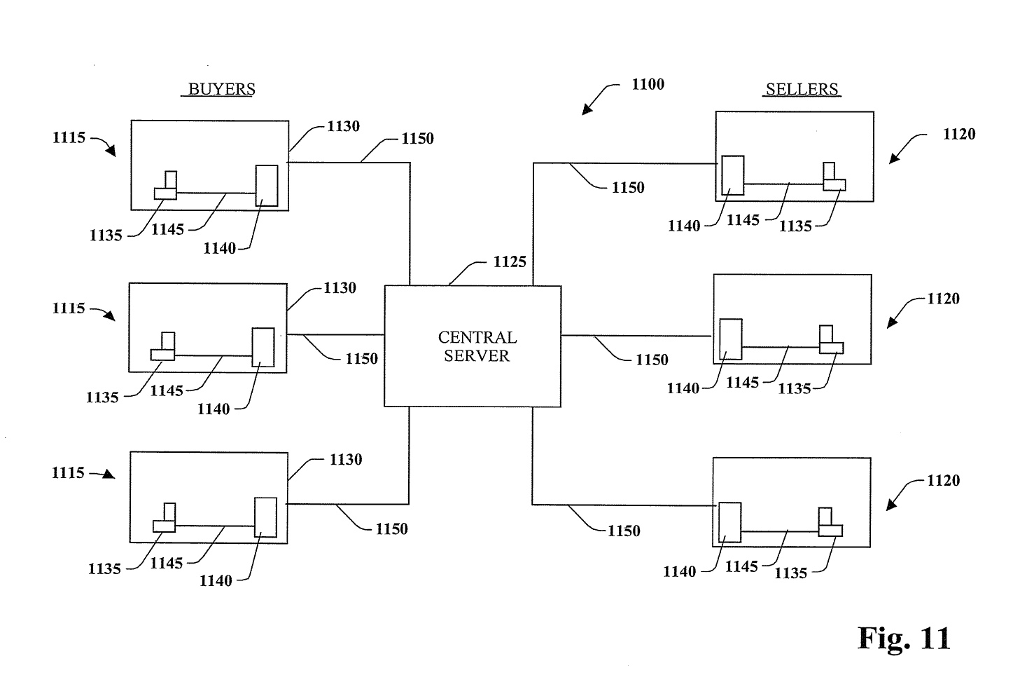

Referring to FIG. 11, a system 1100 is shown in which multiple buyers 1115 and sellers 1120 are electronically linked via a central server 1125. As discussed in more detail below, the central server 1125 is configured to provide the buyers 1115 and sellers 1120 with a convenient forum in which to buy and sell goods in accordance with a volume pricing methodology described herein. The forum may, for example, be a pre-established Internet web page where sellers 1120 are able to post product information and the buyers 1115 are able to order the products. The volume pricing scheme preferably calls for a seller 1120 to post a pricing structure for a product which provides discounted pricing as more products are purchased during a preset “open session” period. Each buyer 1115 is able to place an order for the product during the open session at the then current price. At the end of the open session, the total quantity of products ordered by all buyers 1115 is calculated, and the product is sold to all buyers 1115 at the same lowest price based on the preset price for that quantity amount. In this manner, each of the buyers 1115 work together to increase the total quantity of products purchased so that all of the buyers 1115 realize discounted pricing due to the cumulative order.

Each of the buyers 1115 and sellers 1120 may access the central server 1125 in any of a variety of ways. For example, in the subject embodiment, each buyer 1115 and seller 1120 is shown to be part of separate establishments 1130 which include one or more respective computer systems 1135 and local servers 1140. The computer systems 1135 may, for example, be a desktop or laptop computer with a local area network (LAN) interface for communicating over a network backbone 1145 to the local server 1140. The local servers 1140, in turn, interface with the central server 1125 via a network cable 1150 or the like. It will be appreciated that while the subject embodiment depicts the computer system 1135 communicating with the central server 1125 via hardwired network connections, in an alternative embodiment the computer system 1135 may interface with the central server 1125 using a modem, wireless local area and/or wide area networks, etc. Further, it will be appreciated, that while the buyers 1115 and sellers 1120 are shown to communicate with the central server 1125 via different computer systems 1135, it will be appreciated that the buyers 1115 and/or sellers 1120 may access the central server 1125 from the same computer system 1135.

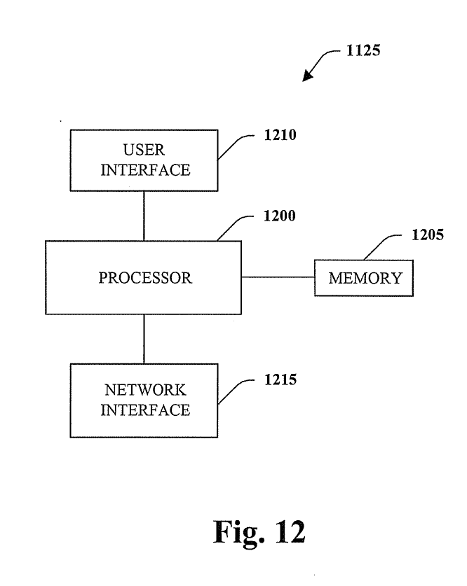

Turning now to FIG. 12, a block diagram of the hardware components of the central server 1125 is shown. In particular, the central server 1125 includes a central processor 1200 for performing the various functions described herein. A memory 1205 is coupled to the processor 1200 and stores operating code and other data associated with the operations of the central server 1125. A user interface 1210 is also coupled to the processor 1200 and provides an interface through which the central server 25 may be directly programmed or accessed. The user interface 1210 may, for example, be an alphanumeric keyboard and mouse. A network interface 1215 coupled to the processor 1200 provides multiple connections for transceiving information with buyers 1115 and sellers 1120 over the network cables 1150.

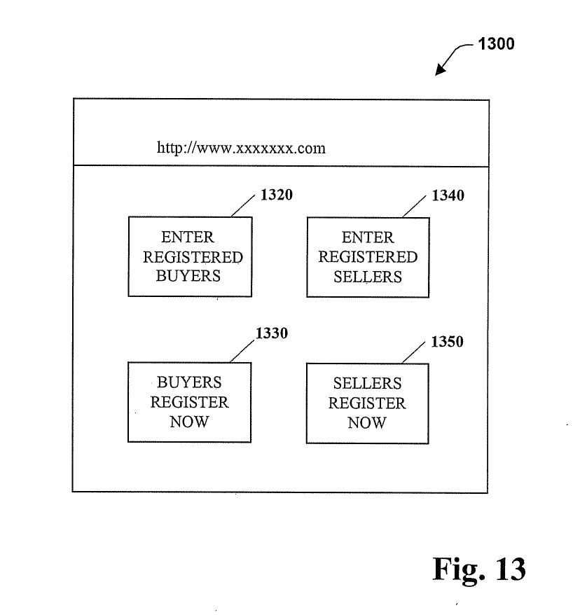

Turning now to FIG. 13, an exemplary Internet web page 1300 which provides buyers 1115 and sellers 1120 with access to a forum for conducting business using the volume pricing methodology described in detail below, is shown. The web page 1300 is shown in to include hyperlinks for handling both registered and unregistered buyers and sellers of products. For example, as shown in FIG. 13, registered buyers may select a hyperlink to a registered buyer login screen via hyperlink 1320 while non-registered buyers may select a hyperlink to a non-registered buyer registration screen via hyperlink 1330. Similarly, registered sellers may select a hyperlink to a registered seller login screen via hyperlink 1340, while non-registered sellers may select a hyperlink to a non-registered seller registration screen via hyperlink 1350. While the present embodiment shows separate hyperlinks for buyers and sellers, it will be appreciated that such hyperlinks could alternatively be combined and the status of buyer or seller could be determined during a later stage in the login procedure.

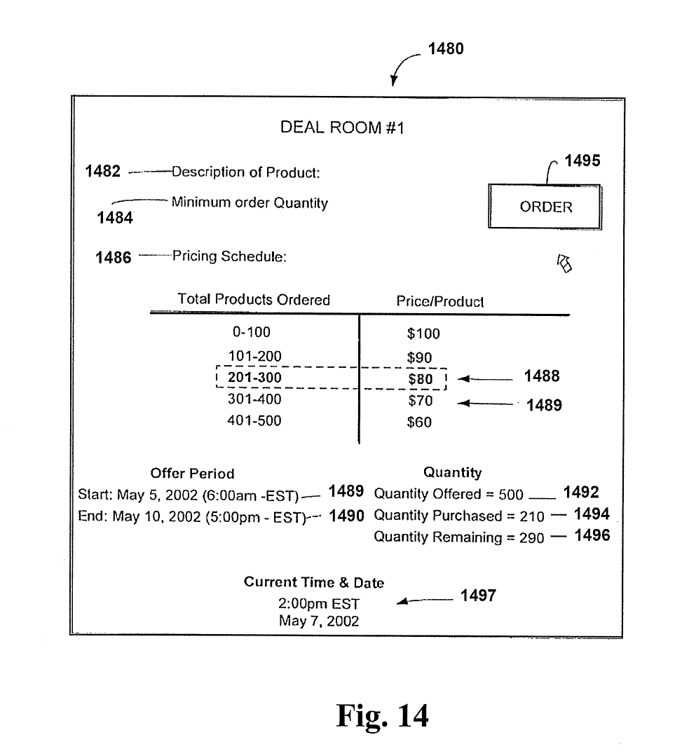

Turning now to FIG. 14, in accordance with one embodiment of the subject claimed innovation, registered sellers 1120 set up deal rooms 1480 in which registered buyers 1115 are able to order products. The deal rooms 1480 provide a convenient forum for sellers to receive orders from multiple buyers during an “open session” period. Based on the cumulative orders received at the end of the open session period, a seller provides all buyers with the same quantity discount for the product regardless of what the price of the product was at the time each buyer placed the order. Thus, in accordance with the subject embodiment, each buyer is able to benefit from other buyers ordering the same product since the cumulative orders received at the end of the open session determines the price for all buyers 1115 placing orders during the open session.

As will be discussed in more detail below, the deal rooms 1480 of the subject embodiment are set up to display the following information which is input from the seller 1120 and/or calculated by the processor 1200 of the central processor 1125 during an open session: product name/description 1482; minimum order quantity 1484; price schedule 1486 with current price level highlighted 1488; offer start time 1489; offer end time 1490; total quantity of products made available 1492; total quantity purchased to date 1494; total quantity available 1496; current time and date 1497. The time between the offer start time and the offer end time is referred to as the “open session” period. Based on such information, buyers 1115 visiting the deal room 1480 can make an informed decision as to whether they desire to place an order for the product. If a buyer 1115 desires to place an order, the buyer 1115 selects an order icon 1495 displayed within the deal room 1480 to continue the purchasing actions.

For example, in the deal room 1480 shown in FIG. 14, a buyer (Buyer A) visiting the deal room 1480 at time t1 may initially review the current price of a product as highlighted at 1488 and review the end time 1490 for the product offering. At time t1, the price for the product as highlighted at 1488 indicates that the price/product is $80. Further, the total products ordered to date is shown to be a quantity of 220. Buyer A next determines whether they are interested in purchasing the product keeping in mind the minimum order quantity set by the seller 20 which in this case is 10 units. If Buyer A decides to order the product, Buyer A selects the order icon 1495 and places an order for a desired quantity. In the present example, Buyer A places an order for 70 products. After the order is placed, the total products ordered to data is 280 (210+70) and the price/product remains at $80 as determined from the pricing schedule 186. Next, at time t2, another buyer (Buyer B) enters the deal room and decides to place an order for 30 more products. After Buyer B places the order, the total products ordered to date is 310 (280+30) and the price/product is lowered to $70 as determined from the pricing schedule 186. The placing of orders by additional buyers continues until the open session period is over. At the end of the open session period, the price of the product to all of the buyers is the price at the time the open session period ended. For example, in the present instance, if the open session period ended after Buyer B placed their order, the price of the product for Buyer A, Buyer B and all other buyers ordering products during the open session period is $70 even though orders by one or more buyers may have been placed at a higher price level. In this manner, the buyers are able to work together to lower the cost of a product for all 20 buyers. Further, even small buyers who would otherwise not be able to obtain volume discount pricing are able to share in the lowered cost and provide a benefit to the larger buyers.

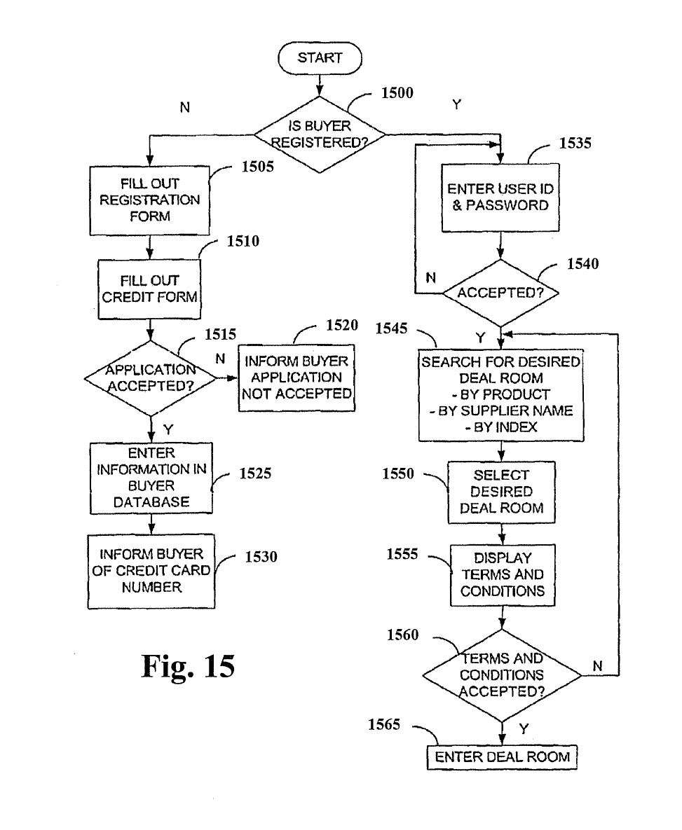

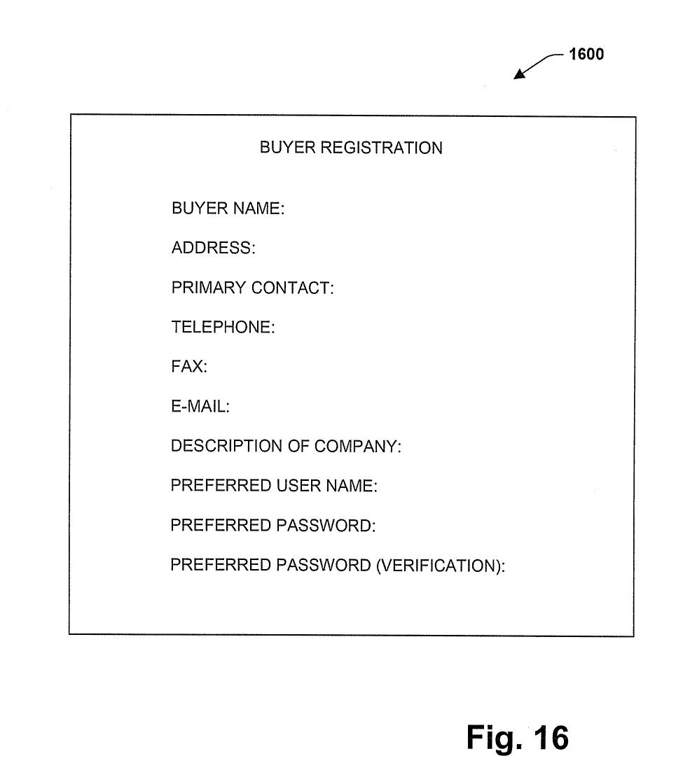

Turning now to FIG. 15, the general actions taken by a buyer 1115 entering the web page 1300 is shown. More particularly, in act 1500 it is initially determined whether a buyer 1115 is registered or not. If the buyer 1115 is not registered, the buyer 1115 selects hyperlink 1330 (FIG. 3) and proceeds to 1505. At 1505 the processor 1200 of the central server 1125 request that the buyer 1115 fill out a registration form. For example, the buyer 1115 is requested to fill out a registration form 1600 such as that shown in FIG. 16. In the present example, the registration form 1600 requests that the buyer 1115 enter the following information: buyer name; address; primary contact person; phone; fax; e-mail; short description of company; preferred login user name; and preferred password. With respect to the user name and password, the processor 1200 is configured to determine whether the selected user name and password combination are available and, if not, to prompt the buyer 1115 to enter a new user name and password until an available combination is selected.

Continuing to refer to FIG. 15, in step 1510, the buyer is requested to fill out a credit card application so that purchases made on the web site may be immediately approved. The credit card registration and approval process may be accomplished via a hyperlink to one of various electronic credit card approval agencies which check the buyer's credit rating and set up a merchant account with a line of credit. For example, an electronic credit card approval agency may be used in conjunction with the subject invention. Next, at 1515, the processor 1200 determines if the credit card application has been approved by the electronic credit card approval agency. If the credit card application has not been approved, the processor 1200 proceeds to act 1520 where a message is sent back to the buyer 1115 indicating regret that they have not been approved for a line of credit and therefore have not successfully completed the registration process. At numeral 1520, a customer service telephone number also is provided to the buyer 1115 in case the buyer has questions and/or desires to pursue registration further.

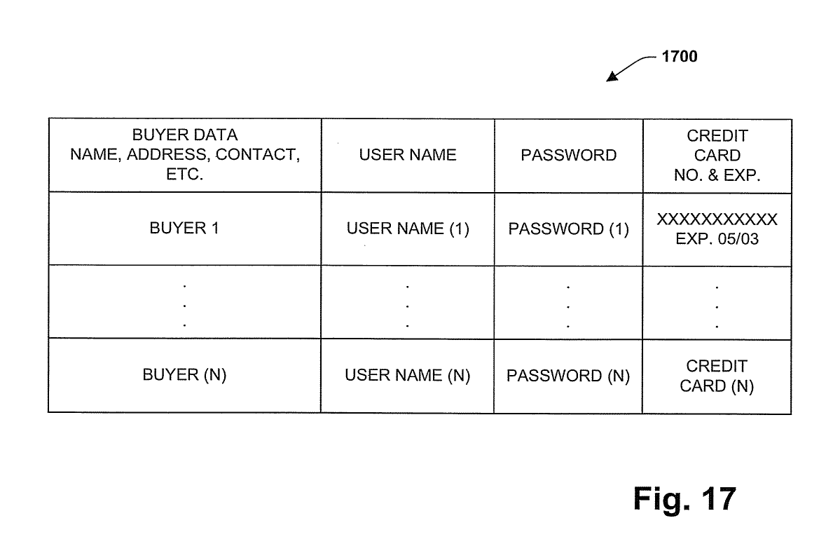

If in act 1515, the processor 1200 is informed that the buyer 1115 has been provided a line of credit and a credit card number has been issued, the processor 1200 proceeds to 1525. At 1525, the buyer information from the registration form 1600 and the newly issued credit card number are stored in a buyer database 1700 (FIG. 17) in the memory 1205 of the processor 1125 (FIG. 12), for example. Next, at 1530, the processor 1200 is configured to provide the buyer 1115 with the newly issued credit card number so that the buyer 1115 is able to purchase products. Further, the processor 1200 is configured to provide a report to a system administrator who then mails a confirmation copy of the buyer's information stored in the buyer's database to the buyer 1115. This completes the buyer's registration process.

Continuing to refer to FIG. 15, if at 1500, a buyer has already registered, the buyer 1115 may login as a registered user by selecting the registered user hyperlink 1320 (FIG. 13). Once selected, the processor 1200, at 1540 prompts the buyer 1115 to enter their user ID and password/pass code. Upon entry of such information, the processor 1200 at 1540 verifies the user ID and password with those stored in the buyer database. If the user ID and password entered by the buyer 1115 does not match any entry in the buyer database, the processor 1200 at 1540 returns to numeral 1535 for re-entry of such information. If, however, at 1540, a valid user ID and password are entered, the processor 1200 proceeds reference numeral 1545.

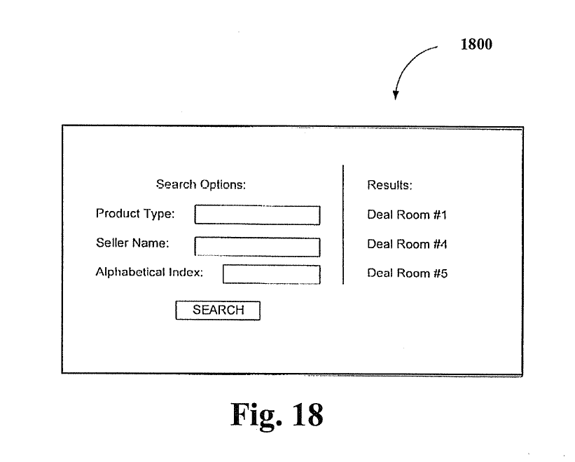

At 1545, the processor 1200 provides the buyer 1115 with a search screen where the buyer 1115 is able to select various deal rooms 1480 they wish to enter. As discussed above, the deal rooms 1480 provide the buyer 1115 with information regarding the sale of a particular product such as, for example, the price structure set up by the seller for the product, the quantity of products sold to date, the time remaining to purchase a product, etc. In order to allow a buyer to quickly find deal rooms 1480 of interest, the 1125 processor 1200 at 1545 provides the buyer 1115 with a search screen 1800 so that active deal rooms 1480 of interest may be found. As shown in FIG. 18, in the subject embodiment, the buyer 1115 is provided with the ability to search based on a variety of different search criteria including “product type”, “seller name”, and “alphabetical index”. Of course, various other manners for allowing a buyer 1115 to select or find a deal room could alternatively be used.

Once a search is completed, the buyer 1115 in step 1550 is able to select a desired deal room 1480 from the results obtained. For example, the buyer 1115 may click on the name of a desired deal room (FIG. 18) using a mouse associated with the computer system 1135. If the buyer 1115 is unsatisfied with the search results or simply desires to re-perform the search, the buyer 1115 at any time is able to return back to a previous screen selecting the “back” function available using an Internet browser such as, for example, Microsoft Internet Explorer, Netscape, etc. Additionally, a hyperlink to various screens, such as the search screen, preferably is provided on each web page.

Upon selecting a deal room 1480, the processor 1200 at 1555 displays a page of standard terms and conditions which the buyer 1115 needs agree to prior to entering the deal room. The terms and conditions relate to the terms governing the sale of the product according to which both the buyer and seller are willing to conduct business. If the terms and conditions are not accepted, the processor 1200 returns the buyer 1115 to numeral 1545 so that another deal room 1480 may be selected and/or another search may be performed. If, however, at 1560 the terms and conditions are accepted, the processor 1200 proceeds to allow the buyer 1115 to enter the selected deal room 1480 at 1565.

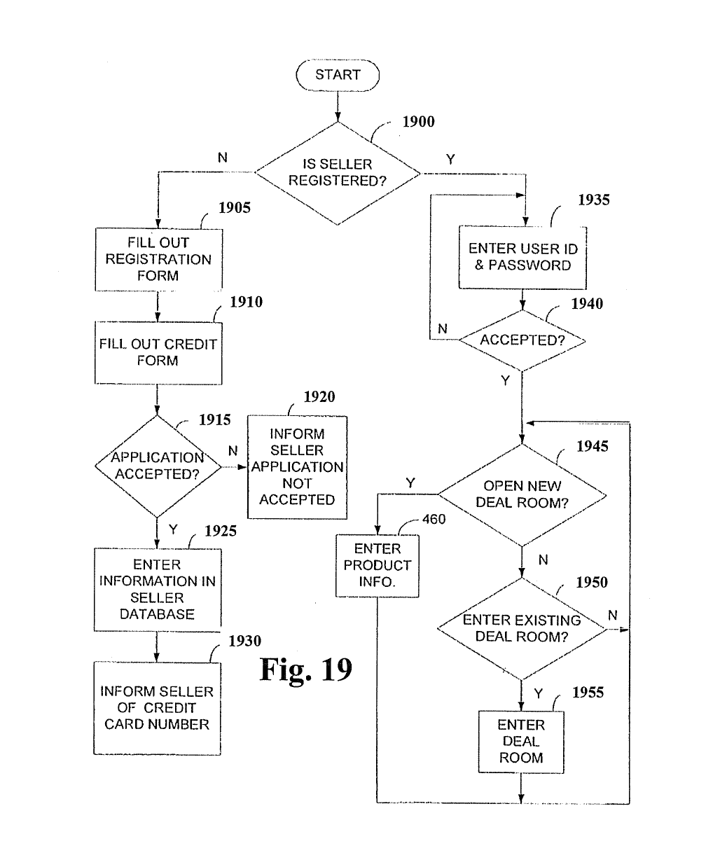

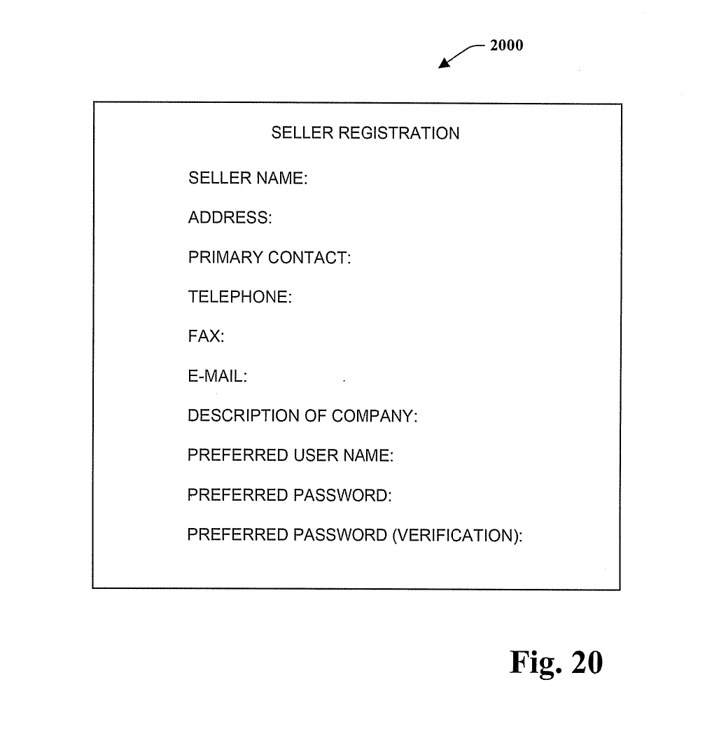

Proceeding now to FIG. 19, the operations of the processor 1200 of the central server 1125 in handling sellers 1120 is depicted. In particular, the processor 1200 at numeral 1900 initially determines whether a seller 1120 is registered or not based on which hyperlink 1340, 1350 (FIG. 13) the seller 1320 selects. If the seller 1120 selects hyperlink 1350 indicating the seller is not registered, the processor 1200 proceeds to numeral 1905. At 1905, the processor 1200 provides the seller 1120 with a seller's registration form 2000 (FIG. 20) to fill out. The registration form 200 is similar to the registration form 1600 for the buyer 1115 and allows the seller 1120 to select a preferred user ID and password. Once completed, the processor 1200 proceeds to step 1910 where the seller 1120 is requested to submit a credit card application so that all costs and fees associated with conducting business using deal rooms may be directly billed to the seller's credit card. As discussed above, the credit card approval process may occur by a third party vendor accessible via a hyperlink.

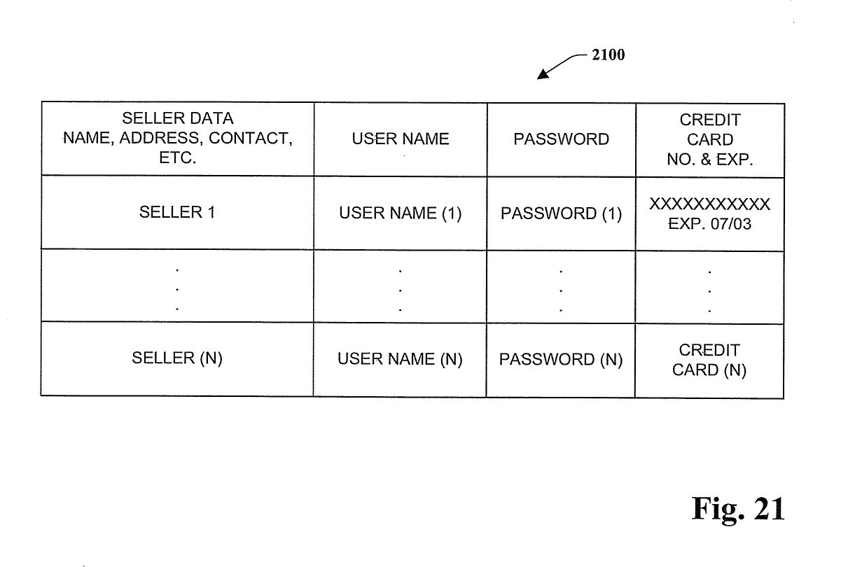

Once the credit card application is submitted by the seller 1120, the processor 1200 proceeds to act 1915 where the processor 1200 determines if the credit card application has been approved. If the credit card application has not been approved, the processor 1200 proceeds to numeral 1920 where the seller 1120 is informed that their credit card application has not been approved and the seller 1120 is provided with a customer service telephone number so that the seller 1120 may optionally set up the account in a different fashion. If, however, at numeral 1915 the credit card application is accepted, the processor 1200 proceeds to act 1925 where the seller information is stored in a seller database 2100 (FIG. 21). Finally, at numeral 1930, the processor 1200 is configured to provide the seller 1120 with the newly issued credit card number so that the seller 1120 is able to open deal rooms. Further, the processor 1200 is configured to provide a report to a system administrator who then mails a confirmation copy of the seller's information stored in the seller's database to the seller 1120. This completes the seller's registration process.

Continuing to refer to FIG. 19, if at 1900 a seller has already registered, the seller 1120 may login as a registered user by selecting the registered user hyperlink 1340 (FIG. 13). Once selected, the processor 1200, at 1935 prompts the seller 1120 to enter their user ID and password. Upon input of the user ID and password, the processor 1200 proceeds to act 1940 where the processor 1200 verifies a valid user ID and password have been entered by comparison with the information stored in the seller database 2100 (FIG. 21). If the user ID and password entered by the seller 1120 does not match any entry in the seller database 2100, the processor 1200 at 1940 returns to 1935 for re-entry of such information. If, however, at 1940, a valid user ID and password are entered, the processor 100 proceeds to numeral 1945.

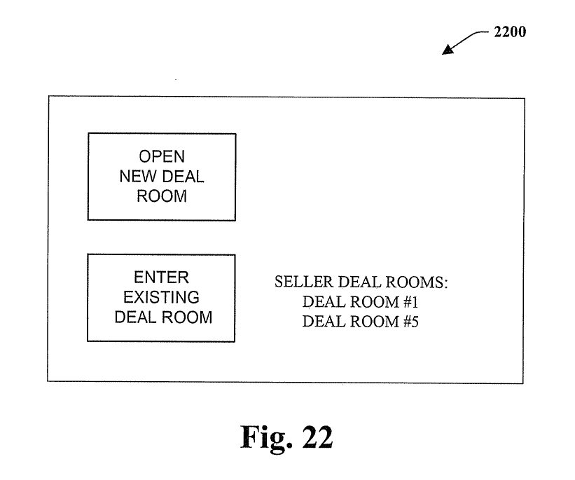

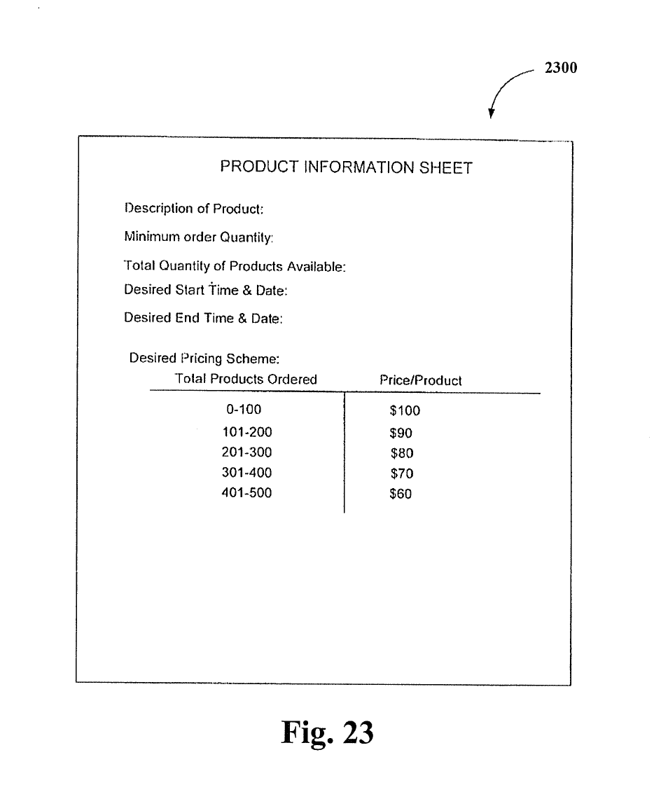

Upon successful entry of a user ID and password, the seller 1120 is provided with a seller option screen 2200 as shown in FIG. 22. For example, the seller 1120 may decide to open a new deal room 1480 where a product may be placed for sale or the seller 1120 may decide to view a current deal room 1480 to determine the status of a given transaction. Accordingly, if at 1945, the processor 1200 determines that the seller 1120 desires to open a new deal room, the processor 1200 proceeds to act 1960. At 1960, the processor 1200 requests that the seller 1120 enter the product information for the deal room they desire to open into a product information screen 2300. For example, in the subject embodiment the information requested is shown in FIG. 23 to include: product name and short description; minimum order quantity accepted; total quantity of products available; start time for offer; end time for offer; and a product pricing schedule. As discussed above, the processor 1200 utilizes the information input from the seller 1120 to display deal rooms 1480 for viewing by registered buyers 1115.

Continuing to refer to FIG. 19, if at 1945, the seller 1120 has not selected to open a deal room, the processor 1200 determines at 1950 whether the seller 1120 has decided to enter an existing deal room 1480. In the subject embodiment of the invention, the seller 1120 is limited to entering those deal rooms which they have opened. Accordingly, if the processor 1200 determines that the seller does desire to enter a deal room 1480, the processor 1200 provides the seller 1120 with a list of deal rooms 1480 which the seller has opened. Upon selection of one of the deal rooms 1480, the processor 1200 proceeds to numeral 1955 where the deal room 1480 is displayed to the seller 1120. If a deal room 1480 is not entered in 1950, or following acts 1955 and 1960, the processor 1200 returns to numeral 945.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to cany computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

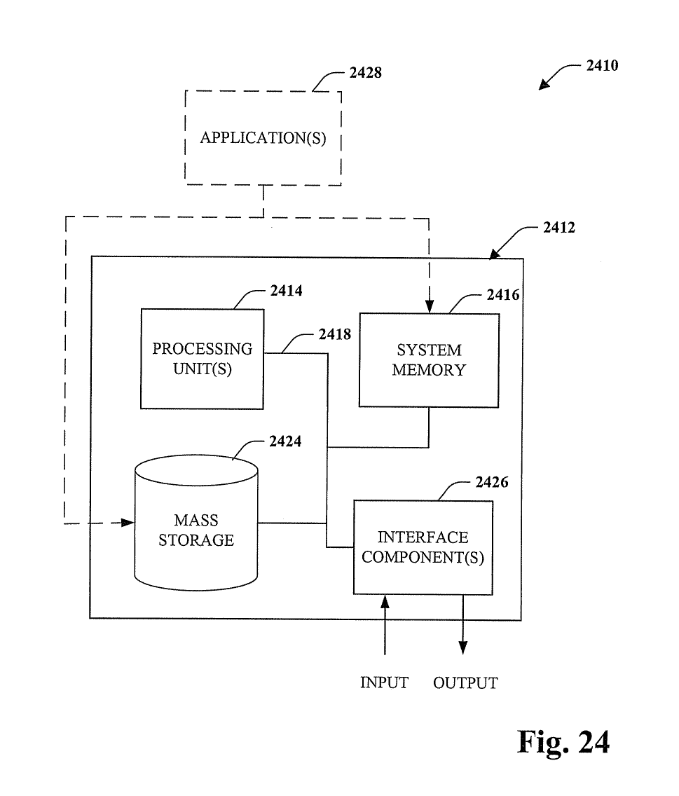

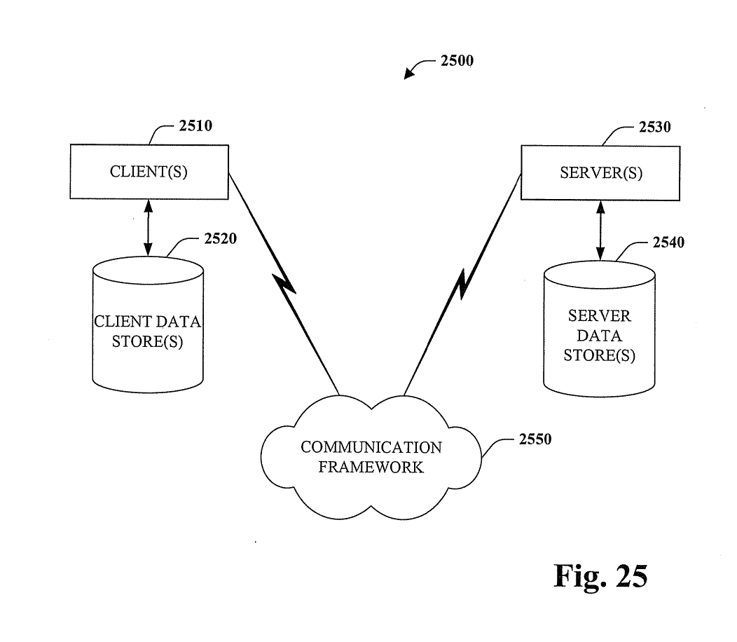

In order to provide a context for the various aspects of the disclosed subject matter, FIGS. 24 and 25 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, handheld computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 24, an exemplary environment 2410 for implementing various aspects disclosed herein includes a computer 2412 (e.g., desktop, laptop, server, hand held, programmable consumer or industrial electronics . . . ). The computer 2412 includes a processing unit 2414, a system memory 2416 and a system bus 2418. The system bus 2418 couples system components including, but not limited to, the system memory 2416 to the processing unit 2414. The processing unit 2414 can be any of various available microprocessors. It is to be appreciated that dual microprocessors, multi-core and other multiprocessor architectures can be employed as the processing unit 2414.

The system memory 2416 includes volatile and nonvolatile memory. The basic input/output system (BIOS), containing the basic routines to transfer information between elements within the computer 2412, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 2412 also includes removable/non-removable, volatile/non-volatile computer storage media. FIG. 24 illustrates, for example, mass storage 2424. Mass storage 2424 includes, but is not limited to, devices like a magnetic or optical disk drive, floppy disk drive, flash memory or memory stick. In addition, mass storage 2424 can include storage media separately or in combination with other storage media.

FIG. 24 provides software application(s) 2428 that act as an intermediary between users and/or other computers and the basic computer resources described in suitable operating environment 2410. Such software application(s) 2428 include one or both of system and application software. System software can include an operating system, which can be stored on mass storage 2424, that acts to control and allocate resources of the computer system 2412. Application software takes advantage of the management of resources by system software through program modules and data stored on either or both of system memory 2416 and mass storage 2424.

The computer 2412 also includes one or more interface components 2426 that are communicatively coupled to the bus 2418 and facilitate interaction with the computer 2412. By way of example, the interface component 2426 can be a port (e.g., serial, parallel, PCMCIA, USB, FireWire . . . ) or an interface card (e.g., sound, video, network . . . ) or the like. The interface component 2426 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 2412 to output device(s) via interface component 2426. Output devices can include displays (e.g., CRT, LCD, plasma . . . ), speakers, printers and other computers, among other things.

FIG. 25 is a schematic block diagram of a sample-computing environment 2500 with which the subject innovation can interact. The system 2500 includes one or more client(s) 2510. The client(s) 2510 can be hardware and/or software (e.g., threads, processes, computing devices). The system 2500 also includes one or more server(s) 2530. Thus, system 2500 can correspond to a two-tier client server model or a multi-tier model (e.g., client, middle tier server, data server), amongst other models. The server(s) 2530 can also be hardware and/or software (e.g., threads, processes, computing devices). The servers 2530 can house threads to perform transformations by employing the aspects of the subject innovation, for example. One possible communication between a client 2510 and a server 2530 may be in the form of a data packet transmitted between two or more computer processes.

The system 2500 includes a communication framework 2550 that can be employed to facilitate communications between the client(s) 2510 and the server(s) 2530. Here, the client(s) can correspond to search engine user computing devices and the server(s) can provide the functionality of the volume pricing offer search systems, as previously described. The client(s) 2510 are operatively connected to one or more client data store(s) 2560 that can be employed to store information local to the client(s) 2510. Similarly, the server(s) 2530 are operatively connected to one or more server data store(s) 2540 that can be employed to store information local to the servers 2530. By way of example, a user (e.g., buyer and/or seller) can login to one or more servers 2530 via a client 2510 and provide a profile including information about the user corresponding to the user's credit rating or the like. The server(s) 2530 can persist this information to data store(s) 2540.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A system for electronically conducting business, the system comprising:
at least one processor;
memory coupled to the at least one processor, wherein the memory stores instructions executable by the at least one processor to:
discover group purchasing offers on a seller's website;
index and store the group purchasing offers in a database;
accept product purchasing criteria from a buyer; and
retrieve from the database group purchasing offers based at least upon the product purchasing criteria from the buyer, wherein the group purchasing offers provide the buyer a discounted price when other buyers purchase within a specified time period.
